(19) United States
(12) Patent Application Publication
(10) Pub. No.: US 2024/0352774 A1
(43) Pub. Date: Oct. 24, 2024

(54) DOUBLE ROTARY LOCK WITH ELECTRONIC ACTUATOR

(71) Applicant: A.L. Hansen Manufacturing Co., Waukegan, IL (US)

(72) Inventor: Doug Juga, Pleasant Prairie, WI (US)

(73) Assignee: A.L. Hansen Manufacturing Co., Waukegan, IL (US)

(21) Appl. No.: 18/137,229

(22) Filed: Apr. 20, 2023

(51) Int. Cl. E05B 83/40; E05B 15/02; E05B 65/08; E05B 81/06; E05C 3/24

(52) U.S. Cl. CPC E05B 83/40; E05B 15/0205; E05B 65/0811; E05B 81/06; E05C 3/24; E05B 2015/023

(57) ABSTRACT

A double rotary lock includes a housing defining an interior space, and lock and latch members rotatably mounted in the interior space. A link member is coupled to the lock member and is rotatable with the lock member. An electronic linear actuator is mounted in the interior space of the housing and is coupled to the link member and rotates the link member and the lock member between lock and unlock positions. A sliding door assembly, and method of locking a sliding door are also provided.

### TECHNICAL FIELD

The present invention relates generally to a rotary lock, and in particular to a double rotary lock with an electronic actuator, and also to sliding door assemblies and methods of assembling and use the rotary lock.

### BACKGROUND

Rotary latches are known to be used in vehicles, for example vehicles having sliding doors, which may be slid between closed and open positions. In such vehicles, a double rotary latch, such as disclosed in U.S. Pat. No. 4,835,997 (the entire disclosure of which is hereby incorporated herein by reference), may engage opposing strike components in respective open and closed positions. The latch may be locked by actuating an interior lock actuator, or by locking the latch exteriorly with exterior lock actuator such as a key. In either case, the user must manually engage the lock actuator.

### SUMMARY

Briefly stated, in one aspect, one embodiment of a double rotary lock includes a housing defining an interior space and having longitudinally spaced first and second strike channels positioned on opposite sides of the housing. The first and second strike channels are shaped and configured to receive first and second strike components. A latch member is rotatably mounted in the interior space of the housing and includes spaced apart first and second strike engaging members adapted to releasably engage one of the first or second strike components respectively. The latch member is rotatable about a rotation axis between an unlatched position, wherein a first strike engaging member is positioned such that the first strike component can be received in the first strike channel and the second strike engaging member is positioned such that the second strike component can be received in the second strike channel, and a latch position, wherein the first strike engaging member blocks the first strike channel and the second strike engaging member blocks the second strike channel. A lock member is rotatably mounted in the interior space of the housing. The lock member is rotatable between a first lock position and a first unlock position, wherein the lock member is engaged with and prevents rotation of the latch member when the latch member is in the latch position and the lock member is in the first lock position, and wherein the lock member is disengaged from the latch member when the lock member is in the first unlock position. A link member is coupled to the lock member in the interior space of the housing. The link member is rotatable with the lock member between the first lock position and the first unlock position. An electronic linear actuator is mounted in the interior space of the housing and is coupled to the link member. The linear actuator includes an actuator portion moveable along a linear path between a second lock position and a second unlock position. The linear actuator rotates the link member and the lock member between the first lock position and the first unlock position as the actuator portion is moved between the second lock position and second unlock position.

In another aspect, one embodiment of a sliding door assembly includes a frame having spaced apart first and second frame members defining a doorway. The first frame includes a first strike component located at a first height and the second frame includes a second strike component located at a second height, wherein the second height is different than the first height. A door is slidably mounted to the frame, wherein the door is slidable between an open position and a closed position. A double rotary lock is engageable with the first or second strike components.

In yet another aspect, one embodiment of a method of locking a sliding door in an open or closed position includes sliding a door having a rotary latch relative to a door frame having spaced apart first and second strike members, disposing one of the first and second strike elements through one of a first and second strike channels formed in the rotary latch and thereby rotating a latch member with the one of the first and second strike elements from an unlatched position to a latch position, moving an actuator portion of an electronic linear actuator along a liner path, rotating a link with the actuator portion, and rotating a lock member to a lock position with the link and thereby engaging the latch member with the lock member. The method may further include sending an electrical signal to the linear actuator.

The various aspects and embodiments provide significant advantages over other rotary locks and sliding door assemblies, and methods for the use thereof. For example, and without limitation, the rotary lock, and the electronic linear actuator in particular, may be easily actuated, without having to manually interface or lock the door. In this way, the door may be quickly and easily locked and unlocked, whether by a local input device such as a push button, or with a remote fob, thereby providing the user with greater flexibility and convenience. In addition, the linear actuator may be quickly and easily replaced simply by moving the actuator in a lateral direction relative to the link to thereby decouple the actuator and link.

The present embodiments of the invention, together with further objects and advantages, will be best understood by reference to the following detailed description taken in conjunction with the accompanying drawings.

### BRIEF DESCRIPTION OF THE DRAWINGS

FIG. 1 is a side view of a vehicle configured with a left side sliding door having a pair of spaced apart strike components and a double rotary lock.

FIG. 2 is an exterior view of the double rotary lock.

FIG. 3A is an interior left side perspective view of one embodiment of a double rotary lock.

FIG. 3B is an interior right side perspective view of the double rotary lock shown in FIG. 3A.

FIG. 4 is a rear perspective view of the double rotary lock shown in FIG. 3A.

FIG. 5 is a front view of the double rotary lock shown in FIG. 3A.

FIG. 6 is a cross-sectional view of the double rotary lock taken along line 6-6 in FIG. 5.

FIG. 7 is a side view of the double rotary lock shown in FIG. 3A.

FIG. 8A is an exploded rear perspective view of the rotary lock shown in FIG. 3A.

FIG. 8B is an exploded front perspective view of the rotary lock shown in FIG. 3A.

FIG. 9 is a front perspective view of an alternative embodiment of a double rotary lock.

FIG. 10 is a front perspective view of an alternative embodiment of a double rotary lock.

FIG. 11A is an interior view of a one embodiment of a rotary lock with a latch member in a latch position and a lock member in a lock position.

FIG. 11B is an exterior view of the rotary lock shown in FIG. 11A.

FIG. 12A is an interior view of the rotary lock shown in FIG. 11A with the latch member in an unlatched position and the lock member in the lock position.

FIG. 12B is an exterior view of the rotary lock shown in FIG. 12A.

FIG. 13A is an interior view with the linear actuator in a lock position.

FIG. 13B is an interior view with linear actuator in an unlock position.

### DETAILED DESCRIPTION OF THE PRESENTLY PREFERRED EMBODIMENTS

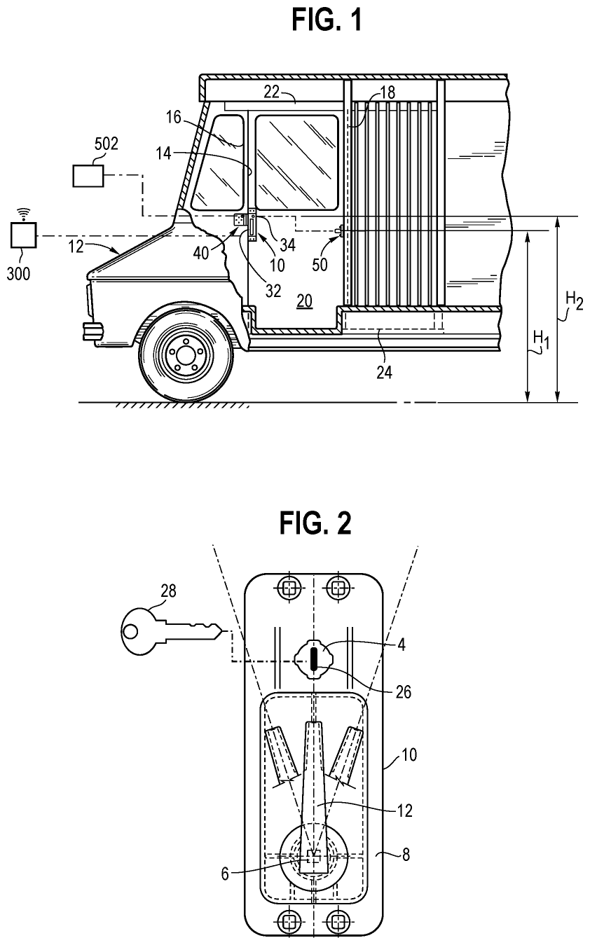

It should be understood that the term “plurality,” as used herein, means two or more. The term “coupled” means connected to or engaged with, whether directly or indirectly, for example with an intervening member, and does not require the engagement to be fixed or permanent, although it may be fixed or permanent. The terms “first,” “second,” and so on, as used herein are not meant to be assigned to a particular component so designated, but rather are simply referring to such components in the numerical order as addressed, meaning that a component designated as “first” may later be a “second” such component, depending on the order in which it is referred. It should also be understood that designation of “first” and “second” does not necessarily mean that the two components or values so designated are different, meaning for example a first direction may be the same as a second direction, with each simply being applicable to different components. The terms “upper,” “lower,” “rear,” “front,” “fore,” “aft,” “vertical,” “horizontal,” “right,” “left,” “inboard,” “outboard” and variations or derivatives thereof, refer to the orientations of an exemplary lock assembly and vehicle, shown in FIG. 1, from the perspective of a driver.

Referring to FIGS. 1 and 2, a vehicle 12 is configured with a doorway 14 having first and second strike members 40, 50 disposed on opposite sides thereof and mounted to frame members 16, 18. The strike members are arranged at first and second heights (H1, H2), which are different. A sliding door 20 is moveable on upper and lower guides 22, 24 between a closed and open position relative to said doorway. A rotary lock 10 is coupled to the sliding door, and is configured to releasably engage the first strike member 40 when the door 20 is closed and to releasably engage the second strike member 50 when the door 20 is open. A handle 12 is secured to a plate member 8 and is rotatable about a rotation axis 6. An exterior lock actuator, shown as a lock cylinder 4 having a key passageway 26 is coupled to the plate member. A key 28 may be inserted into the passageway 26 and then rotated to move the lock actuator, and associated lock member 130, from an unlocked position to a locked position. The handle 12 is accessible from the exterior of the vehicle and is rotated to disengage a latch member 30 from one of the strike members 40, 50, thereby permitting the door 20 to be slid between the open or closed position. The key 28 may be rotated to lock the latch member 30 and prevent the strike member 40, 50 from being disengaged therefrom, or to unlock the latch member 30 and thereby permit the handle 12 to be rotated to unlatch the door 20.

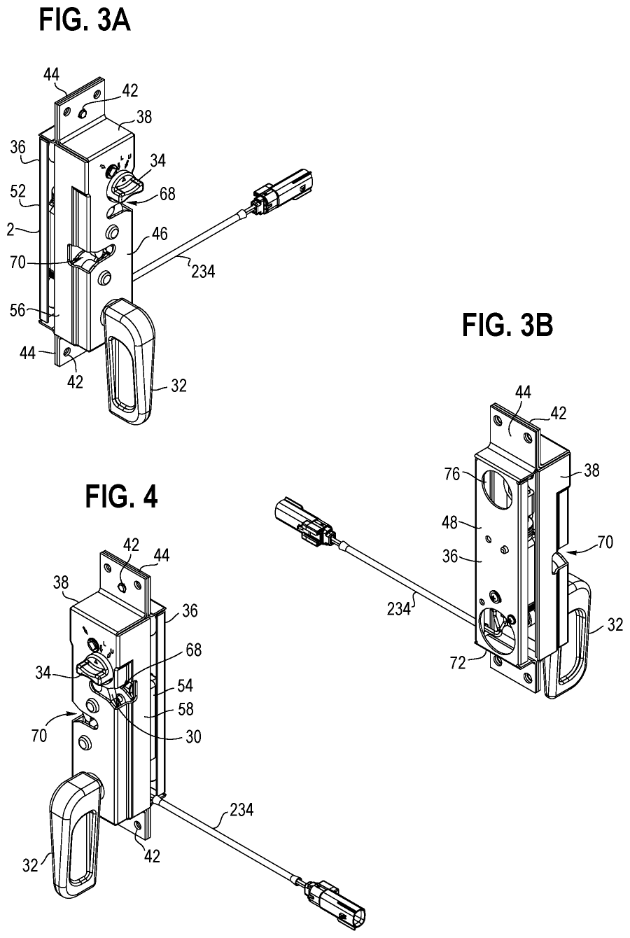

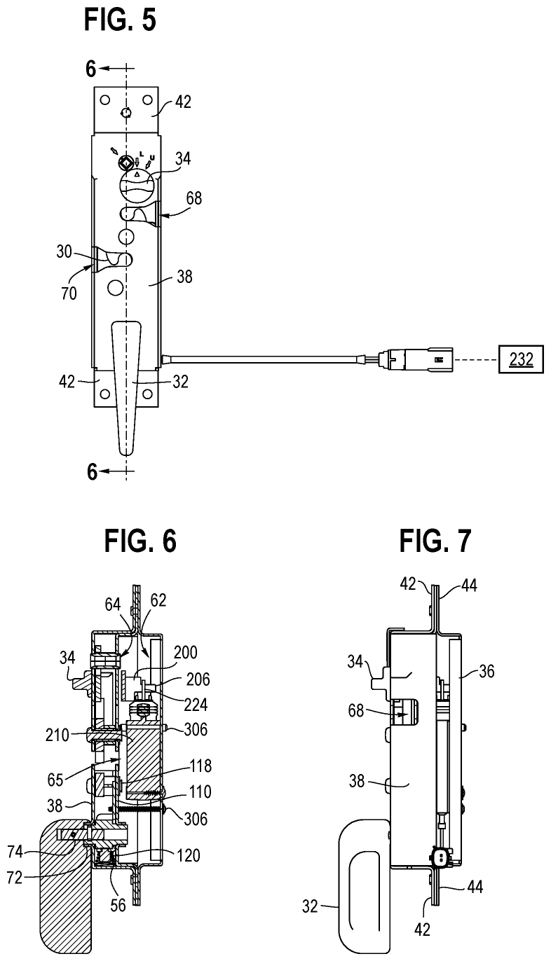

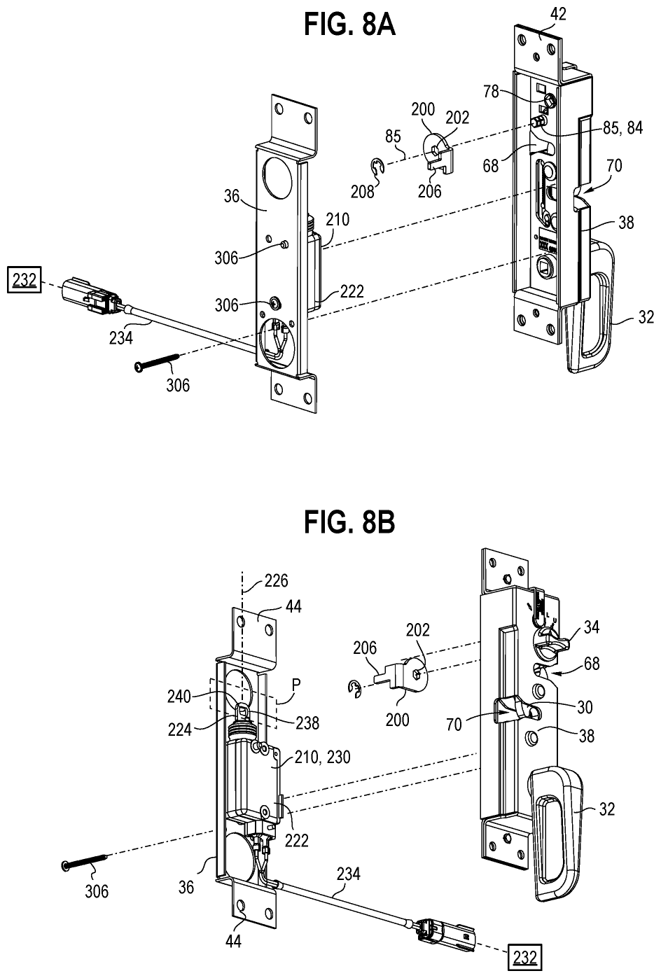

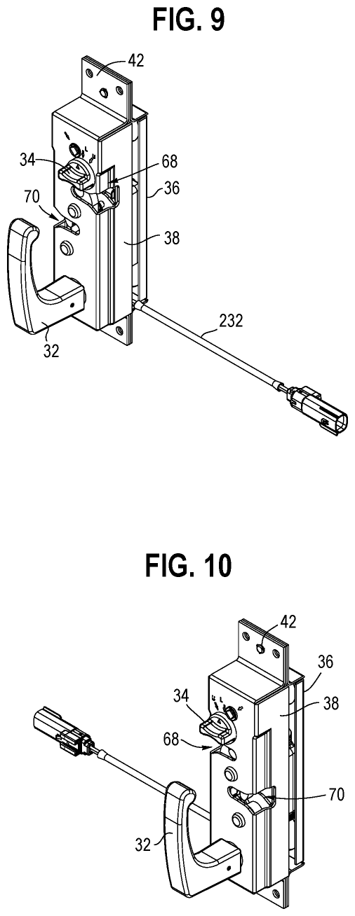

Referring to FIGS. 3A-10, a second, interior handle 32 is provided. The interior handle also may be rotated to unlatch the door 20. An interior lock actuator 34, shown as a knob or lever, is provided to lock or unlock the latch member 30.

As shown in FIGS. 3A-10, the rotary lock includes a housing 2. The housing includes first and second housing components 36, 38, each having a pair of opposite end flanges 42, 44. Each housing component has a top plate 46, 48 and four side walls 52, 54, 56, 58 forming a recess 62, 64 in each housing component respectively, with the recess 64 of the second housing being deeper than the recess 62 of the first housing by virtue of the height of the respective side walls, and with the recesses 62, 64 defining an interior space of the housing. The flanges 42, 44 of the first and second housing components are mated together, with the first housing coupled in the second housing component such that an interior space 65 is formed between the respective top plates 46, 48.

The second housing component 38 has a pair of longitudinally offset openings 68, 70 formed in opposite side walls 58 thereof, with the openings further extending from the side walls inwardly along the top plate. The openings 68, 70 define a pair of offset strike channels, each positioned and shaped to receive one of the first and second strike members 40, 50. The first and second housing components each have an opening 72 shaped to receive coaxial shaft(s) 74. Opposite ends of the shaft(s) 74 are non-rotatably coupled to the exterior and interior handles 12, 32, for example by way of non-circular interfacing sockets. At least the first housing component further includes an opening 76 shaped and positioned to receive a shaft 78 extending from the lock cylinder 4. Conversely, at least the second housing component 38 includes an opening shaped 82 and positioned to receive a shaft 84 extending from the interior lock actuator 34. Of course, it should be understood that the openings in either housing component can be formed in the other housing component, or that the interior and exterior lock actuators may be coaxial.

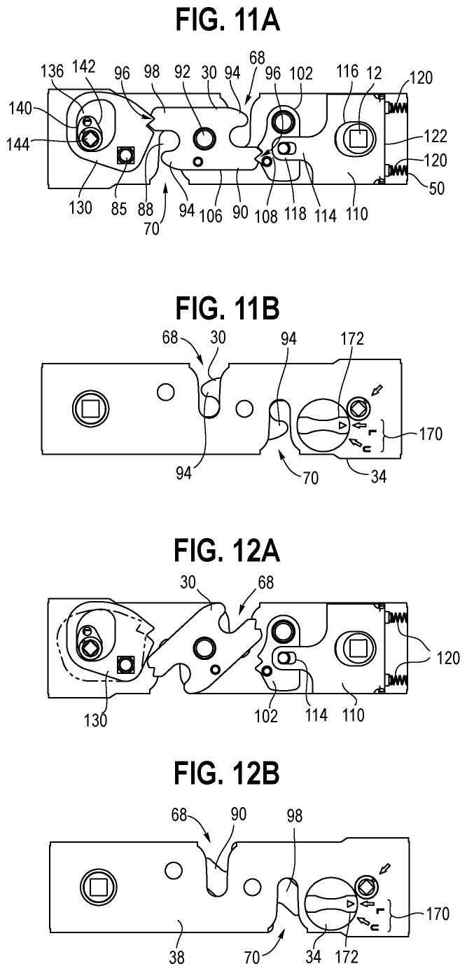

Referring to FIGS. 3A-13B, the rotary latch includes a latch member 30 rotatably mounted about a rotational axis 92 in the space or recess formed between the first and second housing components. The latch member includes a pair of laterally offset strike engaging members 94 extending in opposite directions relative to each other. The latch member 30 further includes a latching portion 90 laterally offset from a locking portion 98, each configured with a catch configuration 96. In one embodiment, each of the strike engaging members, latching portion and locking portion are configured as arms. In one embodiment, each catch configuration 96 includes at least one tooth, or corresponding recess shaped to receive a tooth or protuberance. Of course, it should be understood that other types of catch configurations, including various detents, deformable interfaces, hook and loop fasteners, indexing members, etc., and/or combinations thereof, may also work. The latching and locking portions 90, 98 are offset from respective ones of the strike engaging members 94 so as to form opposing recesses 86, 88 therebetween, with the recesses dimensioned and shaped to receive respective ones of the strike members.

A keeper member 102 is rotatably mounted in the recess between the first and second housing components about a second rotation axis 104, which is parallel to and spaced from the first rotation axis 92. The keeper member includes a catch configuration 108, including at least one tooth in one embodiment. A biasing member 106, shown as a tension spring, extends between and is coupled to the latch member 30 and keeper member 102. The biasing member 106 biases the latch member 30 and keeper member 102 toward each other, such that rotation of either of those members in one rotational direction (e.g., clockwise or counterclockwise) about its axis 92, 104 tends to rotate the other member in the same rotational direction.

An actuator 110 includes a spring plate 112 having a lug 114 with an opening 116, shown as a slot, engaged with a post 118 protruding from the keeper at a spaced apart location from the rotation axis. A biasing member 120, configured in one embodiment as a pair of compression springs, are positioned between a bottom 122 of the actuator and a bottom side wall 56 of the second housing component 38. It should be understood that the biasing member can be configured as a single tension spring, one or more compression, torsion or cantilever springs. Rotation of either handle rotates a rocker cam 124, which thereby engages and moves the spring plate 112 downwardly away from the keeper member 102 against a biasing force of the biasing member 120. As a result, the keeper member 102 is rotated away from the latch member 30, and the corresponding catch configurations 108, 96 are thereby disengaged from each other. At the same time the biasing member 106 pulls the latch member 30 and rotates the latch member 30 to an unlatched position.

A lock member 130 is non-rotatably mounted to the interior actuator 34, for example by a non-rotatable interface with the shaft 84, and is rotatable about a pivot axis 85 defined thereby. The lock member 130 is configured with a catch configuration 132, which may include at least one tooth or a recess defined thereby. In one embodiment, the lock member has an opening 134 defining a cam profile/surface 136. A cam member 140 is disposed in the opening 134 and is non-rotatably secured to the post or shaft 78 of the exterior lock actuator, such that rotation of the shaft/post, for example by rotation of the key 28, rotates the cam member about an axis 144. The cam member has an exterior cam profile/surface 142 that engages the interior cam surface 136 of the lock member as the exterior lock actuator is rotated. Of course, it should be understood that the positions of the exterior and interior lock actuators may be reversed.

As shown in FIGS. 3A-10, 13A and 13B, a link member 200 is coupled to the lock member in the interior space of the housing. The link member is rotatable with the lock member 130 between the lock position and the unlock position. The link member may be non-rotatably secured to the shaft 84, for example with a square or polygonal opening 202, and is rotatable about the axis 85. In one embodiment, the link member includes a plate 204 including the opening 202 with the interface that non-rotatably fits on the shaft 84. A clip 208 holds the link member 200 on the shaft 84. The link member 200 includes a post 206 extending from the plate, for example orthogonally, such that the post is parallel to, but radially spaced apart from, the axis 85. In this way, as the link member 200 rotates about the axis 85, the post 206 follows an arcuate path relative to the axis 85.

An electronic linear actuator 210 also is mounted in the interior space of the housing and is operably coupled to the link member 200. The linear actuator 210 may include a base 222 and an actuator portion 224, configured as a shaft or tube in one embodiment, that moves in an out of the base 222 along a linear path 226. The linear actuator may be an electric linear actuator including an electric motor 230, housed in or defining the base. The motor 230 may be electrically connected to a power source, such as a battery 232, with a wire harness 234, which provides power to the electric motor 230. In one embodiment, the linear actuator may have a linear screw moving the actuator portion, for example by way of a nut disposed on the actuator portion and interfacing with the screw, which is rotated by the motor 230. Rotation of the screw moves the actuator portion up and down along the linear path. The linear actuator may be configured as a pneumatic or hydraulic actuator.

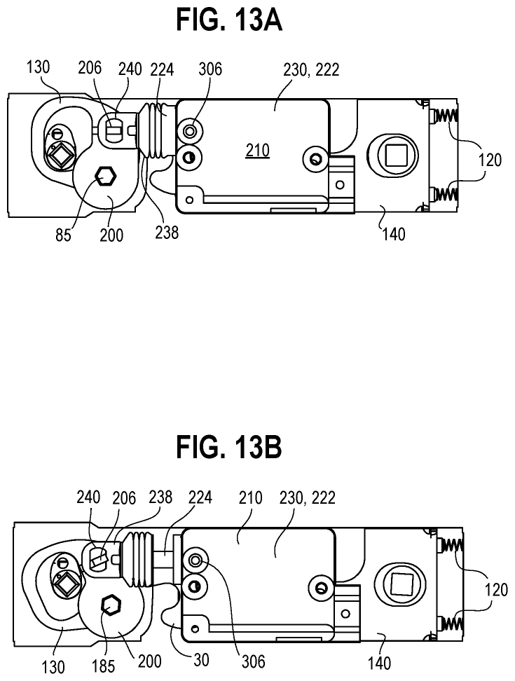

The actuation portion 224 is move along the linear path 226 between a lock position and an unlock position, as shown in FIGS. 13A and 13B. The linear actuator has a moveable end portion 238 with an opening 240 formed therein. The opening 240 may be configured as an elongated slot, having for example linear sides and curved ends. The opening 240 defines, or is formed in a plane (P) that is orthogonal to the axis 85 and the post 206, such that the linear actuator 210 may be coupled to the link member 200 simply by sliding the linear actuator 210 laterally relative to the link member 200 in a direction parallel to the axis 85 and thereby inserting the post 206 into and through the opening 240, regardless of whether the post 206 or the opening 240 is positioned on the link member 200 or the actuator portion 224. It should be understood that in an alternative embodiment, the post extends from the actuator portion and an opening is formed in the link, with the post and opening cooperating to rotate the link member 200 in response to a linear movement of the actuator portion 224.

As shown in FIG. 1, an input device 300, 302 is connected to the linear actuator 210 and may be actuated to provide an input signal to the linear actuator 210, including for example an electrical signal. The input device 300, 302 may include a switch, for example a button, that sends signals to move the actuator portion up to a locked position or down to an unlocked position. The input device 302 may be hard wired, or may be configured as a remote fob 300, which sends a wireless signal to the linear actuator, whether directly or through a controller, such as a microcontroller, which may be embedded in the base of the linear actuator. In other embodiments, a transponder and touch pad technology may be used as the input device. Either input device 300, 302 may include a pair of user interface inputs, e.g., buttons, for example an unlock button and a lock button, which send a corresponding lock or unlock signal to the linear actuator 210 to either extend or retract the actuator portion. The user interface inputs may include indicia to identify the lock and unlock function.

In one embodiment, the linear actuator 210 is secured to the rear housing 36, for example with fasteners 306. During assembly, the two housings 36, 38 are moved laterally relative to each other, e.g., along a direction parallel to the axis 85, with the post 206 being inserted into the opening 240, wherein after the two housing components 36, 38 may be coupled together, for example with fasteners joining the flanges 42, 44. Disassembly occurs in the opposite fashion, with the two housings 36, 38 being disengaged and with the housings being moved laterally apart, e.g., along a direction parallel to the axis 85, such that the post 206 is removed from the opening 240 and the link member 200 is disengaged from the linear actuator 210 and the actuator portion 224 in particular. The linear actuator 210 may thereafter be decoupled from the rear housing 36, for example if damaged, by removing the fasteners 306 and be replaced with another linear actuator, which is first secured to the rear housing 36, which is then secured to the front housing 38.

As shown in FIGS. 3A-10, the post 206 on the link member 200 is inserted through the opening 240, such that the link member 200 is coupled to the linear actuator 210 through surface contact between the post 206 and the periphery of the opening 240, for example one of the flat sides that defines a cam surface. In one embodiment, the sliding contact is the only connection between the linear actuator 210 and the link member 200. As the actuator portion 224 is extended relative to the base 222, or moved upwardly, the actuator portion, and in particular a bottom cam surface defined by the opening 240, moves the post 206 along an arcuate path to an unlocked position about the axis 85 as the post 206 travels along a surface of the opening 240, or bottom side thereof, so as to rotate the post 206, link member 200 and lock member 130 about the axis 85. The slotted opening 240 in the actuator portion 224 allows for the relative sliding movement between the post 206 and the actuator portion 224 as the post 206 moves along an arc about the axis 85, while maintaining contact between the actuator portion 224 and the post 206. When retracting the actuator portion 224 into the base 222 to a lock position, the upper cam surface of the opening 240, or upper linear side, engages and moves the post 206 along an opposite arcuate path relative to the axis 85 so as to rotate the link member 200 and lock member 130 to respective lock positions. When extended or retracted, the linear actuator 210, and the actuator portion 224 in particular, reciprocally rotates the link member 200 and the lock member 130 between the lock position and the unlock position as the actuator portion 224 is reciprocally moved along the linear path 226 between the lock position and unlock position. It should be understood that in other embodiments, the linear actuator may be extended to a locked position, and retracted to an unlocked position. It should be understood that, in an alternative embodiment, the opening 240, which defines one or more cam surfaces and may be configured as a slot, may be formed in the link member, while the post 206 extends from the actuator portion and is inserted in the opening. Again, movement of the actuator portion 224 rotates the link member 200 and locking member 130 about the axis 85.

In operation, and starting with the door 20 in an intermediate, unlatched position, a user slides the door 20 to an open or closed position. Prior to engagement of the latch member 30 with one of the strike components 40, 50 the latch member should be in an unlatched position, with the strike engaging members 94 positioned such that the strike component can be received in the strike channel 68, 70. In one embodiment, the strike engaging members 94 are disposed substantially entirely outside of the strike channel 68, 70. In this position, the latching portion 90 and locking portion 98 of the latch member presents strike surfaces across the respective strike channels 68, 70, which strike surfaces may be engaged by the corresponding strike components 50, 40.

In this position, the lock member 130 of the first embodiment may be moved (e.g., by rotation) to a lock position, either by manipulation of the interior actuator 34, by way of rotation of the exterior actuator (e.g., key 28 and cam 140), which independently operate to rotate the lock member, or by actuation of the linear actuator 210. Manual operation of the actuator 34 or key 28 and cam 140 may override and extend or retract the actuator portion 224 of the linear actuator 210.

As the door 20 is moved to the closed or open position, one of the strike components 40, 50 enters one of the strike channels 68, 70, engages the strike surface of either of the latching or locking portions 90, 98, and thereby rotates the latch member 30 from the unlatched position to a secondary latch position. In a secondary latch position of the latch member, the strike engaging members 94 at least partially block the strike channels 68, 70 with the strike component 40, 50 trapped in the strike channel 68, 70 between the strike engaging member 94 and one of the latching or locking portions 90, 98 of the latch member. At the same time, the latching portion 90 of the latch member rotates relative to the keeper member 102, which is rotated and temporarily biased away from the latch member until the corresponding catch configurations 108, 96 are engaged, thereby releasably securing the latch member 30 in the secondary latch position with the keeper member 102 in a secondary keeper position. If unlocked, the handles 12, 32 can be rotated. Rotation of either handle 12, 32 moves the spring plate 112 against the force of the springs 120 and thereby draws the keeper member 102 away from the latch member 30, moving the keeper member from a secondary keeper position to a disengaged position and thereby releasing the latch member 20. The latch member 30 is then rotated to an unlatched position by way of the biasing force of the biasing member 106. In this position, the strike members 40, 50 are freely moveable out of the strike channels 68, 70.

As noted above, indicia 170 can be applied to the housing, with the actuator 34 including an indicator 172, configured for example as a pointer, directed at one or more of the indicia to provide additional visual indicia to the user. For example and without limitation, the indicia 170 can be configured in the form of alphanumeric characters (e.g., “U” for unlocked and “L” for locked), text (“Unlocked” and “Locked”), graphics, other characters or patterns, and/or combinations thereof. This type of auxiliary indicia can also be applied to the exterior of the housing, or on the plate, with the key member 28 acting as an indicator. In any event, the user, whether inside or outside the vehicle, is provided with indicia (by way of the feel and visual of the key 28 and interior actuator 34, as well as by the feel and visual of the indicia 170) that the door is closed and locked or unlocked. Likewise, the input device 300, 302, including for example a pair of buttons, or fob (e.g., key fob) may include indicia (e.g., graphical or alphanumerical characters) for indicating a locked and unlocked configuration.

As the door 20 is moved an additional amount, for example to the closed position, the strike component 40, 50 moves further into the strike channel 68, 70 and, through engagement with the strike surface of the latching and locking portions, rotates the latch member 30 from the secondary latch position to the primary latch position. In the primary latch position, the strike engaging members 94 substantially block the strike channels 68, 70 with the strike component 40, 50 trapped in a corresponding one of the strike channels 68, 70, depending on whether the door is in an open or closed position, between the strike engaging member 94, one of the latching or locking portions 90, 98 and/or an edge portion of the strike channel. At the same time, the latching portion 90 of the latch member again rotates relative to the keeper member 102, with the keeper member being rotated and temporarily biased away from the latch member until the corresponding catch configurations 108, 96 are further engaged. In this primary keeper position, the keeper member 102 releasably secures the latch member 30 in the primary latch position. If unlocked, the handles 12, 32 can be rotated, which in turn moves the spring plate 112 and draws the keeper member 102 away from the latch member 30, thereby decoupling the catch portions 96, 108 by moving the keeper member from a primary keeper position to a disengaged position. In this position, the keeper member 102 releases the latch member 30, which is then rotated to an unlatched position by way of the biasing force of the biasing member 106.

When the latch member 30 is in a primary latch position, the lock member 130 may be rotated to a lock position by the interior actuator 34, by rotation of the exterior lock actuator, e.g., the key 28 and cam 140, or by actuation of the linear actuator 210. For example, in one embodiment, the key is rotatable 90°. In this way, the user is provided with tactile and visual indicia that the door is fully closed and the latch member 130 is fully latched in a primary latch position. In addition, the actuators 34, 28 can function as an indicator 172 relative to indicia 170 on the housing, providing further visual and/or tactile indicia that the latch member 30 is fully latched in a primary latch position and can be locked in that position.

The latch member 30 is non-rotatable when the lock member 130 is in the lock position, regardless of whether the keeper member 102 is engaged or disengaged with the latch member 30. To unlatch the door 20, the interior or exterior actuators 34, 28, 140 are simply rotated to an unlock position, or the linear actuator 210 is actuated by an input device 300, 302, which in turn rotates the lock member 130 to an unlock position. In a first embodiment, the lock member 130 is simply rotated out of the way, such that subsequent movement of the keeper member 102 to a disengaged position will release the latch member 30, which is rotated to an unlatched position by the biasing member 106. In this embodiment, as discussed above, the lock member 130 may be returned to a lock position when the latch member 30 is in a disengaged position, but the lock member 130 is non-movable to the lock position when the latch member 30 is in the secondary latch position.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

What is claimed is:

1. A double rotary lock comprising:
a housing defining an interior space and comprising longitudinally spaced first and second strike channels positioned on opposite sides of the housing, wherein the first and second strike channels are shaped and configured to receive first and second strike components;
a latch member rotatably mounted in the interior space of the housing, wherein the latch member comprises spaced apart first and second strike engaging members adapted to releasably engage one of the first or second strike components respectively, and wherein the latch member is rotatable about a rotation axis between an unlatched position, wherein a first strike engaging member is positioned such that the first strike component can be received in the first strike channel and the second strike engaging member is positioned such that the second strike component can be received in the second strike channel, and a latch position, wherein the first strike engaging member blocks the first strike channel and the second strike engaging member blocks the second strike channel;
a lock member rotatably mounted in the interior space of the housing, wherein the lock member is rotatable between a first lock position and a first unlock position, wherein the lock member is engaged with and prevents rotation of the latch member when the latch member is in the latch position and the lock member is in the first lock position, and wherein the lock member is disengaged from the latch member when the lock member is in the first unlock position;
a link member coupled to the lock member in the interior space of the housing, wherein the link member is rotatable with the lock member between the first lock position and the first unlock position; and
an electronic linear actuator mounted in the interior space of the housing, wherein the linear actuator is coupled to the link member, wherein the linear actuator comprises an actuator portion moveable along a linear path between a second lock position and a second unlock position, wherein the linear actuator rotates the link member and the lock member between the first lock position and the first unlock position as the actuator portion is moved between the second lock position and second unlock position.

2. The double rotary lock of claim 1 wherein one of the actuator portion or the link member comprises an opening, and wherein the other of the actuator portion or the link member comprises a post inserted into the opening, wherein the actuator portion is moveable along the linear path between the second lock position and the second unlock position, and wherein the post is moveable along an arcuate path within the opening as the actuator portion is moved between the second lock position and the second unlock position.

3. The double rotary lock of claim 2 wherein the actuator portion comprises the opening and wherein the link member comprises the post.

4. The double rotary lock of claim 3 wherein the link member is non-rotatably mounted on a shaft defining a rotation axis of the lock member.

5. The double rotary lock of claim 4 wherein the post extends parallel to the rotation axis of the lock member.

6. The double rotary lock of claim 5 wherein the link member comprises a plate non-rotatably mounted on the shaft, and wherein the post extends from the plate.

7. The double rotary lock of claim 6 wherein the post is spaced apart from the rotation axis.

8. The double rotary lock of claim 5 further comprising a lock actuator mounted to the shaft exteriorly of the housing.

9. The double rotary lock of claim 5 wherein the opening in the actuator portion defines a plane orthogonal to the rotation axis.

10. The double rotary lock of claim 1 wherein the housing comprises a front housing component and a rear housing component removably coupled to the front housing component, wherein the front and rear housing components define the interior space therebetween.

11. The double rotary lock of claim 10 wherein the linear actuator is coupled to the rear housing component.

12. The double rotary lock of claim 11 wherein the linear actuator is disengageable from the link member by moving the linear actuator and rear housing component away from the front housing component along the rotation axis.

13. A sliding door assembly comprising:
a frame comprising spaced apart first and second frame members defining a doorway, wherein the first frame comprises a first strike component located at a first height and the second frame comprises a second strike component located at a second height, wherein the second height is different than the first height;
a door slidably mounted to the frame, wherein the door is slidable between an open position and a closed position;
a double rotary lock mounted to the door and comprising:
a housing defining an interior space and comprising longitudinally spaced first and second strike channels positioned on opposed sides of the housing, wherein the first strike channel receives the first strike component when the door is slid to the closed position, and wherein the second strike channel receives the second strike component when the door is slid to the open position;
a latch member rotatably in the interior space of the housing, wherein the latch member comprises spaced apart first and second strike engaging members, wherein the latch member is rotatable about a rotation axis between an unlatched position, wherein the first strike engaging member is positioned such that the first strike component can be received in the first strike channel and the second strike engaging member is positioned such that the second strike component can be received in the second strike channel, and a latch position, wherein the first strike engaging member blocks the first strike channel and the second strike engaging member blocks the second strike channel;
a lock member rotatably mounted in the interior space of the housing, wherein the lock member is rotatable between a first lock position and a first unlock position, wherein the lock member is engaged with and prevents rotation of the latch member when the latch member is in the latch position and the lock member is in the first lock position, and wherein the lock member is disengaged from the latch member when the lock member is in the first unlock position;
a link member coupled to the lock member in the interior space of the housing, wherein the link member is rotatable with the lock member between the first lock position and the first unlock position; and
an electronic linear actuator mounted in the interior space of the housing, wherein the linear actuator is coupled to the link member, wherein the linear actuator comprises an actuator portion moveable along a linear path between a second lock position and a second unlock position, wherein the linear actuator rotates the link member and the lock member between the first lock position and the first unlock position as the actuator portion is moved between the second lock position and second unlock position.

14. The sliding door assembly of claim 13 wherein one of the actuator portion or the link member comprises an opening, and wherein the other of the actuator portion or the link member comprises a post inserted into the opening, wherein the actuator portion is moveable along the linear path between the second lock position and the second unlock position, and wherein the post is moveable along an arcuate path within the opening as the actuator portion is moved between the second lock position and the second unlock position.

15. The sliding door assembly of claim 14 wherein the actuator portion comprises the opening and wherein the link member comprises the post.

16. The sliding door assembly of claim 15 wherein the link member is non-rotatably mounted on a shaft defining a rotation axis of the lock member.

17. The sliding door assembly of claim 16 wherein the post extends parallel to the rotation axis of the lock member.

18. The sliding door assembly of claim 17 wherein the link member comprises a plate non-rotatably mounted on the shaft, and wherein the post extends from the plate.

19. The sliding door assembly of claim 18 wherein the post is spaced apart from the rotation axis.

20. The sliding door assembly of claim 16 further comprising a lock actuator mounted to the shaft exteriorly of the housing.

21. The sliding door assembly of claim 16 wherein the opening in the actuator portion defines a plane orthogonal to the rotation axis.

22. The sliding door assembly of claim 13 wherein the housing comprises a front housing component and a rear housing component removably coupled to the front housing component, wherein the front and rear housing components define the interior space therebetween.

23. The sliding door assembly of claim 22 wherein the linear actuator is coupled to the rear housing component.

24. The sliding door assembly of claim 23 wherein the linear actuator is disengageable from the link member by moving the linear actuator and rear housing component away from the front housing component along the rotation axis.

25. A method of locking a sliding door in an open or closed position comprising:
sliding a door comprising a rotary latch relative to a door frame having spaced apart first and second strike members;
disposing one of the first and second strike elements through one of a first and second strike channel formed in the rotary latch and thereby rotating a latch member with the one of the first and second strike elements from an unlatched position to a latch position;
moving an actuator portion of an electronic linear actuator along a linear path;
rotating a link with the actuator portion;
rotating a lock member to a lock position with the link and thereby engaging the latch member with the lock member.

26. The method of claim 25 wherein moving the actuator portion comprises actuating an input device and sending an electrical signal to the linear actuator.

27. The method of claim 26 wherein the input device comprises a remote fob. and further comprising sending a wireless signal from the remote fob to the linear actuator.
